(19) United States
(12) Patent Application Publication
(10) Pub. No.: US 2025/0029005 A1
(43) Pub. Date: Jan. 23, 2025

(54) DYNAMIC LOW-RANK ESTIMATION FOR TRANSFORMER-BASED LANGUAGE MODELS

(71) Applicant: Samsung Electronics Co., Ltd., Suwon-si (KR)

(72) Inventors: Ting Hua, Cupertino, CA (US); Xiao Li, Ann Arbor, MI (US); Shangqian Gao, Mountain View, CA (US); Yen-Chang Hsu, Fremont, CA (US); Yilin Shen, Mountain View, CA (US); Hongxia Jin, San Jose, CA (US)

(21) Appl. No.: 18/669,413

(22) Filed: May 20, 2024

Related U.S. Application Data
(60) Provisional application No. 63/527,294, filed on Jul. 17, 2023.

(51) Int. Cl. G06N 20/00; G10L 15/18; G10L 15/26

(52) U.S. Cl. CPC G06N 20/00; G10L 15/18; G10L 15/26

(57) ABSTRACT

A method includes accessing a plurality of weight matrices of a machine learning model. The method also includes, for each weight matrix, decomposing the weight matrix into a U matrix, an S matrix, and a V matrix using singular value decomposition. The S matrix is a diagonal matrix, and a singular group corresponds to each element in the S matrix. The method further includes, for each weight matrix, determining an importance score of each singular group. The importance score of the singular group represents a change in loss if the singular group is removed from the machine learning model. The method also includes, for each weight matrix, ranking the singular groups across the plurality of weight matrices based on the importance scores. In addition, the method includes, for each weight matrix, identifying one or more of the singular groups to prune based on the ranking of the singular groups.

### CROSS-REFERENCE TO RELATED APPLICATION AND PRIORITY CLAIM

This application claims priority under 35 U.S.C. § 119(e) to U.S. Provisional Patent Application No. 63/527,294 filed on Jul. 17, 2023, which is hereby incorporated by reference in its entirety.

### TECHNICAL FIELD

This disclosure relates generally to machine learning systems. More specifically, this disclosure relates to dynamic low-rank estimation for transformer-based language models.

### BACKGROUND

Matrix decomposition methods have been used for compressing transformer-based language models. Previous approaches, such as singular value decomposition (SVD) and importance-weighted variants of SVD, have aimed to minimize reconstruction errors, resulting in the removal of weights associated with small singular values. However, it has been discovered that this goal does not always align with the objective of preserving task performance. This is primarily due to the fact that different parameters often have various influences on the overall performance, whereas standard SVD treats all parameters as equally significant.

### SUMMARY

This disclosure relates to dynamic low-rank estimation for transformer-based language models.

In a first embodiment, a method includes accessing a plurality of weight matrices of a machine learning model. The method also includes, for each weight matrix, decomposing the weight matrix into a U matrix, an S matrix, and a V matrix using singular value decomposition, where the S matrix is a diagonal matrix and a singular group corresponds to each element in the S matrix. The method further includes, for each weight matrix, determining an importance score of each singular group, where the importance score of the singular group represents a change in loss if the singular group is removed from the machine learning model. The method further includes, for each weight matrix, ranking the singular groups across the plurality of weight matrices based on the importance scores. Ina addition, the method includes, for each weight matrix, identifying one or more of the singular groups to prune based on the ranking of the singular groups.

In a second embodiment, an electronic device includes at least one processing device configured to access a plurality of weight matrices of a machine learning model. The at least one processing device is also configured, for each weight matrix, to decompose the weight matrix into a U matrix, an S matrix, and a V matrix using singular value decomposition, where the S matrix is a diagonal matrix and a singular group corresponds to each element in the S matrix. The at least one processing device is further configured, for each weight matrix, to determine an importance score of each singular group, where the importance score of the singular group represents a change in loss if the singular group is removed from the machine learning model. The at least one processing device is also configured, for each weight matrix, to rank the singular groups across the plurality of weight matrices based on the importance scores. In addition, the at least one processing device is configured, for each weight matrix, to identify one or more of the singular groups to prune based on the ranking of the singular groups.

In a third embodiment, a non-transitory machine readable medium contains instructions that when executed cause at least one processor of an electronic device to access a plurality of weight matrices of a machine learning model. The non-transitory machine-readable medium also contains instructions that when executed cause the at least one processor, for each weight matrix, to decompose the weight matrix into a U matrix, an S matrix, and a V matrix using singular value decomposition, where the S matrix is a diagonal matrix and a singular group corresponds to each element in the S matrix. The non-transitory machine-readable medium further contains instructions that when executed cause the at least one processor, for each weight matrix, to determine an importance score of each singular group, where the importance score of the singular group represents a change in loss if the singular group is removed from the machine learning model. The non-transitory machine-readable medium also contains instructions that when executed cause the at least one processor, for each weight matrix, to rank the singular groups across the plurality of weight matrices based on the importance scores. In addition, the non-transitory machine-readable medium contains instructions that when executed cause the at least one processor, for each weight matrix, to identify one or more of the singular groups to prune based on the ranking of the singular groups.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example language model system in accordance with this disclosure;

FIG. 3 illustrates an example dynamic low-rank estimation and compression process in accordance with this disclosure;

FIG. 4 illustrates an example singular group initialization process in accordance with this disclosure;

FIG. 5 illustrates an example importance scoring process in accordance with this disclosure;

FIG. 6 illustrates an example global ranking allocation in accordance with this disclosure;

FIG. 7 illustrates an example global ranking and singular group pruning process in accordance with this disclosure;

FIGS. 8A and 8B illustrate an example rank budget determination process in accordance with this disclosure; and

FIG. 9 illustrates an example method for dynamic low-rank estimation and compression in accordance with this disclosure.

### DETAILED DESCRIPTION

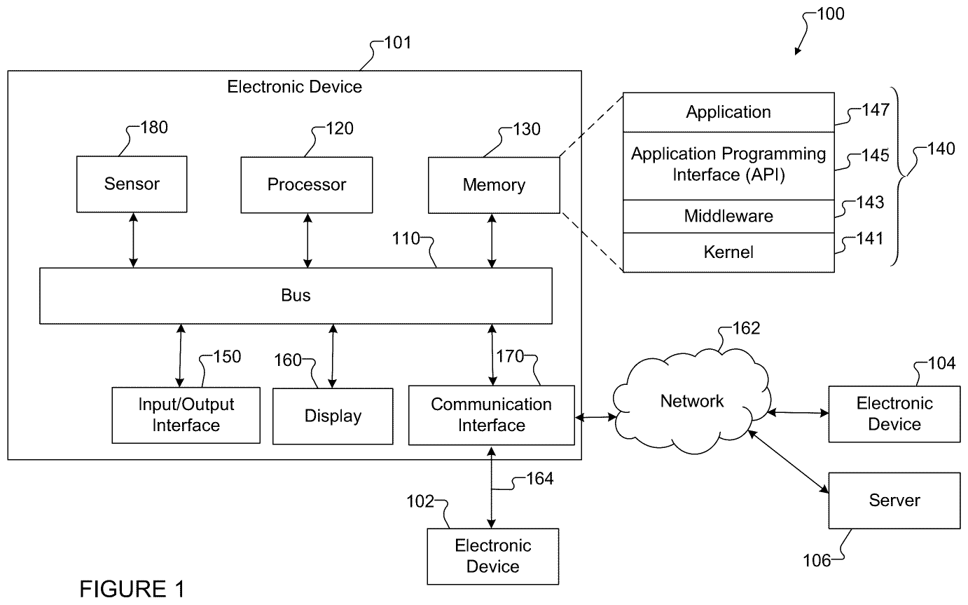

FIGS. 1 through 9, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, matrix decomposition methods have been used for compressing transformer-based language models. Previous approaches, such as singular value decomposition (SVD) and importance-weighted variants of SVD, have aimed to minimize reconstruction errors, resulting in the removal of weights associated with small singular values. However, it has been discovered that this goal does not always align with the objective of preserving task performance. This is primarily due to the fact that different parameters often have various influences on the overall performance, whereas standard SVD treats all parameters as equally significant.

Previous attempts have been made to conduct low-rank estimation on a matrix weighted by Fisher information. However, these approaches need an already fine-tuned model as their starting point to calculate importance scores based on Fisher information and often require an additional round of fine-tuning to attain better performance. While importance-weighted decomposition methods, such as Fisher-Weighted SVD (FWSVD) and True Fischer Weighted SVD (TFWSVD), relax the strong assumption of equal importance for each parameter in SVD, they still rely on unrealistic assumptions. These assumptions include a “stable assumption,” in which the distribution of importance over parameters is assumed to remain relatively stable during the subsequent fine-tuning process, and an “independent assumption,” in which the matrices are assumed to be independent of each other.

Transformer-based language models have obtained significant success in a variety of natural language processing tasks. However, these models are usually pre-trained by a huge corpus with millions or even billions of parameters and are difficult to deploy to resource-constrained devices. Transformer blocks are primarily built with linear layers, which convert input features into output features through a weight matrix. By applying low-rank estimation methods, the large weight matrix in a layer can be decomposed into two smaller matrices, resulting in the creation of two reduced-size linear layers. Also, it is important to note that matrix factorization technologies are orthogonal to other compression approaches such as knowledge distillation or quantization.

This disclosure addresses issues with prior language model compression techniques by providing improved performance techniques for compressing language models that take into consideration importance based on singular groups rather than merely individual parameters as in previous techniques. The described techniques enable global rank allocation across layers by monitoring importance variations rather than assigning uniform ranks to all layers as in previous techniques. The described techniques also provide for dynamic tracking of importance changes rather than merely assigning static importance to each parameters as in previous techniques. The improvements to language model compression of this disclosure have been shown to lead to significantly improved compression results and improved performance, including achieving improved accuracy over previous models while still providing for comparable reductions in the number of parameters in the model.

The language model compression techniques of this disclosure include conducting low-rank estimation throughout a fine-tuning process. Starting with a full-rank matrix, this disclosure provides for gradually reducing the parameter budget level using a scheduler. At each step, the least important singular groups are removed based on their importance scores, which are determined by the amount of impact they contribute to the loss. The importance scores are collectively evaluated for all singular groups within the model, and different ranks can be assigned to each matrix.

The dynamic low-rank estimation processes of this disclosure provide various advantages depending on the implementation. For example, dynamic tracking of importance for singular groups avoids issues with previous techniques such as importance-aware decomposition approaches aimed to optimize an objective weighted by static importance assigned to each parameter. However, assuming that the importance distribution of parameters remains unchanged during fine-tuning is unrealistic. Unlike these prior techniques, this disclosure provides for effectively capturing the dynamic changes in importance associated with singular groups, which leads to improved performance compared to the previous methods based on the static importance assumption.

Additionally, the dynamic low-rank estimation processes of this disclosure provide for improved parameter allocation across matrices. The varying sensitivities of different layers in transformer models during compression are well-established. Given a targeted model size budget, prior techniques assign uniform ranks to all layers. In contrast, this disclosure enables dynamical parameter allocation across layers by monitoring their importance variations, leading to significantly better compression outcomes.

In addition, the dynamic low-rank estimation processes of this disclosure provide reduced computational and storage resources. Unlike previous techniques that rely on already fine-tuned task-specific models, the processes of this disclosure can begin with a general pre-trained model. As a result, there only needs to be a single round of fine-tuning. This significantly reduces the computational overhead compared to approaches that require two rounds of fine-tuning. Additionally, previous techniques require factorization for each fine-tuned task-specific model, which can be increasingly expensive when model sizes get larger. In contrast, embodiments of this disclosure require only a one-time factorization on the base model, which can be shared across all downstream tasks.

Note that while some of the embodiments discussed below are described in the context of use in consumer electronic devices (such as smartphones), this is merely one example. It will be understood that the principles of this disclosure may be implemented in any number of other suitable contexts and may use any suitable device or devices. Also note that while some of the embodiments discussed below are described based on the assumption that one device (such as a server) performs training of a machine learning model that is deployed to one or more other devices (such as one or more consumer electronic devices), this is also merely one example. It will be understood that the principles of this disclosure may be implemented using any number of devices, including a single device that both trains and uses a machine learning model. In general, this disclosure is not limited to use with any specific type(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to dynamic low-rank estimation for machine learning models. For example, as described below, the processor 120 may decompose a weight matrix into a U matrix, an S matrix, and a V matrix using singular value decomposition, where a singular group corresponds to each element in the S matrix. The processor 120 may also determine an importance score of each singular group, rank the singular groups across the plurality of weight matrices based on the important scores, and identify one or more of the singular groups to prune based on the ranking of the singular groups. The processor 120 may further instruct other devices to perform certain operations (such as outputting audio using an audio output device like a speaker) or display content on one or more displays 160. In addition, the processor 120 may receive inputs (such as data samples to be used in training machine learning models) and manage such training by inputting the samples to the machine learning models, receive outputs from the machine learning models, and execute learning functions (such as loss functions) to improve the machine learning models.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to dynamic low-rank estimation for machine learning models. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to dynamic low-rank estimation for machine learning models. For example, as described below, the server 106 may decompose a weight matrix into a U matrix, an S matrix, and a V matrix using singular value decomposition, where a singular group corresponds to each element in the S matrix. The server 106 may also determine an importance score of each singular group, rank the singular groups across the plurality of weight matrices based on the important scores, and identify one or more of the singular groups to prune based on the ranking of the singular groups. The server 106 may further instruct other devices to perform certain operations (such as outputting audio using an audio output device like a speaker) or display content on one or more displays 160. In addition, the server 106 may receive inputs (such as data samples to be used in training machine learning models) and manage such training by inputting the samples to the machine learning models, receive outputs from the machine learning models, and execute learning functions (such as loss functions) to improve the machine learning models.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

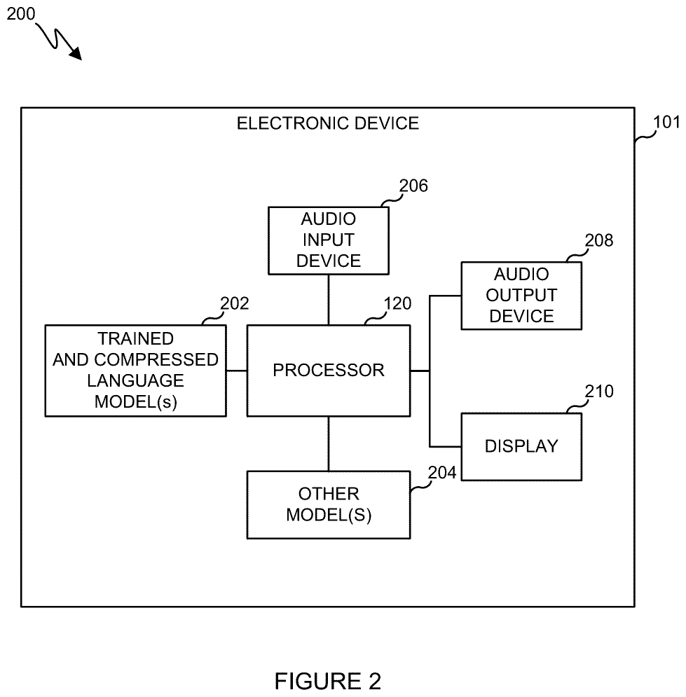

FIG. 2 illustrates an example language model system 200 in accordance with this disclosure. For case of explanation, the system 200 is described as involving the use of the electronic device 101 in the network configuration 100 of FIG. 1. However, the system 200 may be used with any other suitable electronic device(s), such as the server 106, and in any other suitable system(s).

As shown in FIG. 2, the system 200 includes the electronic device 101, which includes the processor 120. The processor 120 is operatively coupled to or otherwise configured to use one or more machine learning models, such as a trained and compressed language model 202. As described in this disclosure, the trained and compressed language model 202 can be a transformer-based language model that is compressed. As described below, the compression process involves each of multiple weight matrices of the language model 202 being decomposed into a U matrix, an S matrix, and a V matrix using singular value decomposition, where a singular group corresponds to each element in the S matrix. An importance score is determined for each singular group, the singular groups are ranked across the weight matrices based on the important scores, and one or more of the singular groups are pruned based on the ranking of the singular groups to provide the resultant trained and compressed language model 202. The trained and compressed language model 202 can be one or more large language models, such as a large language model meta AI (LLaMA) model, a natural language understanding model, or other types of large language models. It will be understood that more than one trained and compressed language model 202 can be used by the electronic device 101.

The processor 120 can also be operatively coupled to or otherwise configured to use one or more other models 204, such as one or more virtual assistant-related models, one or more ASR models, and/or one or more NLU models. It will be understood that the machine learning models 202 and 204 can be stored in a memory of the electronic device 101 (such as the memory 130) and accessed by the processor 120 to perform various tasks such as automated speech recognition and related task performance. However, the machine learning models 202 and 204 can be stored in any other suitable manner.

The system 200 also includes an audio input device 206 (such as a microphone), an audio output device 208 (such as a speaker or headphones), and a display 210 (such as a screen or a monitor like the display 160). These other components can be used for fulfilling requested tasks by the electronic device 101. For example, the processor 120 can receive an audio input from the audio input device 206 and provide the audio input to the trained and compressed language model 202. In some embodiments, the trained and compressed language model 202 generates text based on the audio input and outputs the result to the processor 120. In various embodiments, another trained and compressed language model 202 can be used to convert the text to a user intention and output a result to the processor 120, such as one or more outputs that are used to instruct further action by the electronic device 101.

As a particular example, assume an utterance is received from a user via the audio input device 206 including a phrase or command (such as “hey BIXBY, call mom”). In response, the trained and compressed language model(s) 202 can generate text from the audio input and convert the text to a user intention, which is used by the processor 120 to instruct the audio output device 208 to output “calling Mom.” The processor 120 also causes a phone application or other communication application to begin a communication session with a “mom” contact stored on the electronic device 101 or otherwise in association with the user of the electronic device 101, and display a user interface for the application on the display 210.

Although FIG. 2 illustrates one example of a language model system 200, various changes may be made to FIG. 2. For example, the audio input device 206, the audio output device 208, and the display 210 can be connected to the processor 120 within the electronic device 101, such as via wired connections or circuitry. In other embodiments, the audio input device 206, the audio output device 208, and the display 210 can be external to the electronic device 101 and connected via wired or wireless connections. Further, in some embodiments, one or more of the machine learning models, including the trained and compressed language model 202 and one or more of the other machine learning models 204, can be stored remotely from the electronic device 101, such as on the server 106. Here, the electronic device 101 can transmit requests including inputs (such as captured audio data) to the server 106 for processing of the inputs using the machine learning models, and the results can be sent back to the electronic device 101. In addition, in some embodiments, the electronic device 101 can be replaced by the server 106, which receives inputs from a client device and transmits instructions back to the client device to execute functions associated with instructions included in the inputs.

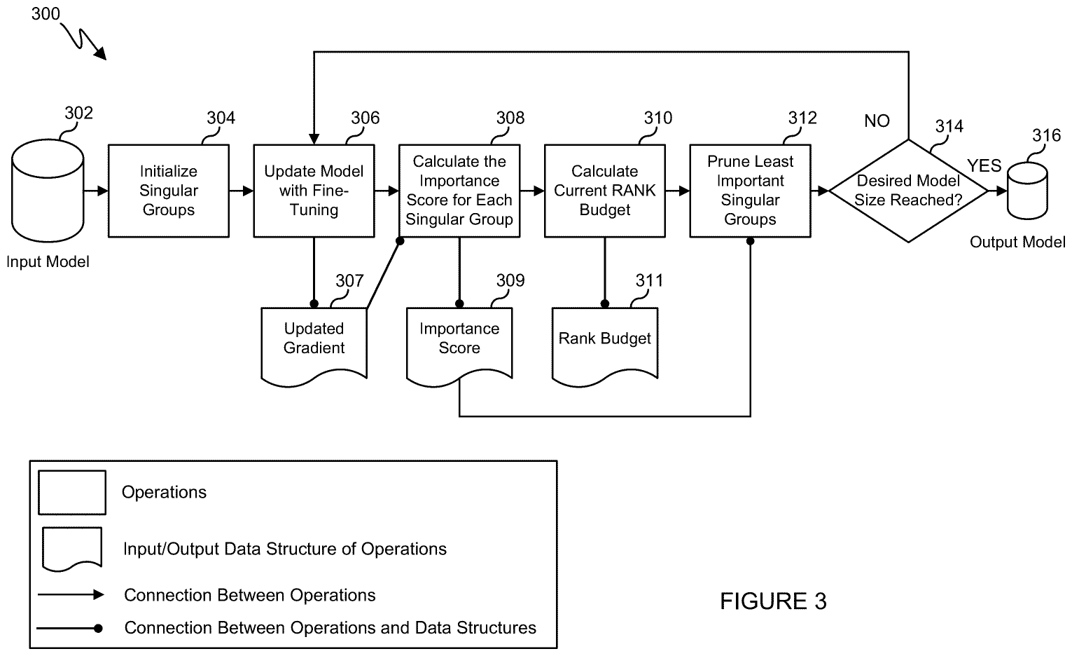

FIG. 3 illustrates an example dynamic low-rank estimation and compression process 300 in accordance with this disclosure. For case of explanation, the process 300 is described as involving the use of the electronic device 101 in the network configuration 100 of FIG. 1. However, the process 300 may be used with any other suitable electronic device (such as the server 106) or a combination of devices (such as the electronic device 101 and the server 106) and in any other suitable system(s).

As illustrated in FIG. 3, the process 300 can include connections between operations of the process 300 and connections between the operations and data structures output by the operations. As shown in FIG. 3, a machine learning model, such as a transformer-based language model, is received or retrieved as an input model 302. In various embodiments, the input model 302 can be a generally-trained model without task-specific training. An initialization operation 304 is performed on each weight matrix of the input model 302 to initialize singular groups for each weight matrix.

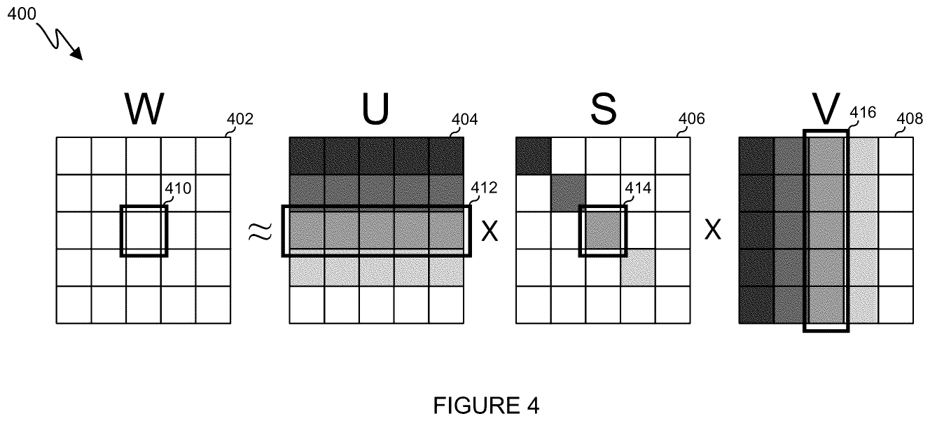

FIG. 4 illustrates an example singular group initialization process 400 in accordance with this disclosure. The singular group initialization process 400 can correspond to the initialization operation 304. For ease of explanation, the process 400 is described as involving the use of the electronic device 101 in the network configuration 100 of FIG. 1. However, the process 400 may be used with any other suitable electronic device (such as the server 106) or a combination of devices (such as the electronic device 101 and the server 106) and in any other suitable system(s).

As shown in FIG. 4, a weight matrix 402 is decomposed, such as by using singular value decomposition (SVD), into a U matrix 404, an S matrix 406, and a V matrix 408. In various embodiments, matrix factorization methods can decompose a large matrix W∈ [symbol] ^{M×N} into smaller matrices, which can be expressed as follows.

$$W = U \sum {V}^{T} \approx ( {U}_{r} {\sum }_{r} ) {V}_{r}^{T} = {P}_{r} {Q}_{r}$$

Here, U∈ [symbol] ^{M×l}, V∈ [symbol] ^{N×l}, and l is the rank of matrix W. Σ is a diagonal matrix composed of non-zero singular values diag(σ₁, . . . , σₗ), where σ₁≥σ₂≥ . . . σₗ>0. Uᵣ, Σᵣ, and Vᵣ are truncated matrices with rank r and serve as approximations to the original matrix. In practice, it is common to represent matrix W as the product of two smaller matrices P∈ [symbol] ^{M×r} and Q⊂ [symbol] ^{r×N} by setting P=US and Q=V^{T}.

Given this, the forward pass of a linear layer in a transformer can be rewritten as follows.

$$h = Wx + b = PQx + b$$

Here, x is the input feature, and b is the bias. The above process can be implemented with two smaller liner layers, whose weight matrix is equal to P and Q correspondingly. The number of parameters in the original weight matrix W is MN, and the combined number of parameters in P and Q is Nr+Mr. Therefore, by utilizing matrix factorization techniques, the model size can be reduced by NM−(Nr+Mr).

As further shown in FIG. 4, the S matrix 406 is a diagonal matrix, and each singular group corresponds to each element in the S matrix. For each individual parameter 410 in the weight matrix 402, singular groups are created each including a row 412 of the U matrix 404, an element 414 of the S matrix 406, and a column 416 of the V matrix 408. Thus, each singular group is a triple-group including {uₖ∈U,σₖ∈S,vₖ∈V}.

The U, S, and V matrices 404, 406, and 408 are thus initialized using decomposition and rearranged into singular groups, where K is the number of singular groups in the model. In some cases, this can be represented as follows.

$$\begin{matrix}U & = \{ {u}_{1} , {u}_{2} , … , {u}_{K} \} & & \{ {u}_{1} , {σ}_{1} , {v}_{1} \} \\ S & = \{ {σ}_{1} , {σ}_{2} , … , {σ}_{K} \} & \to & \{ {u}_{2} , {σ}_{2} , {v}_{2} \} \\ V & = \{ {v}_{1} , {v}_{2} , … , {v}_{K} \} & & ⋯ \\ & & & \{ {u}_{K} , {σ}_{K} , {v}_{K} \}\end{matrix}$$

As also shown in FIG. 4, the rank for W is eventually calculated for however many non-zero elements are included in S. For example, in FIG. 4 the rank is four since the last diagonal element in S is zero as indicated by the shadings of the elements in the matrices 404, 406, 408. The importance of the ranks of the singular group are also shown in FIG. 4 with darker shadings to indicate more important groups.

Returning to FIG. 3, a fine-tuning operation 306 is performed to update the model via fine-tuning and output an updated gradient 307. For instance, the fine-tuning operation 306 can include taking, at the t^{th} step, a stochastic gradient descent step to update elements in each singular group, where k is the index of the singular group and i is the index of each element. In some cases, this can be represented as follows.

$${σ}_{k}^{( t )} ← {σ}_{k}^{( t - 1 )} - η {∇}_{{σ}_{k}} ℒ ,$$

$${u}_{k , i}^{( t )} ← {u}_{k , i}^{( t - 1 )} - η {∇}_{{u}_{k , i}} ℒ .$$

$${v}_{k , i}^{( t )} ← {v}_{k , i}^{( t - 1 )} - η {∇}_{{v}_{k , i}} ℒ .$$

An importance scoring operation 308 is performed using the updated gradient 307. For example, after each step of updating the model at operation 306, the importance scoring operation 308 can calculate the importance scores for each singular group based on their updated gradient 307.

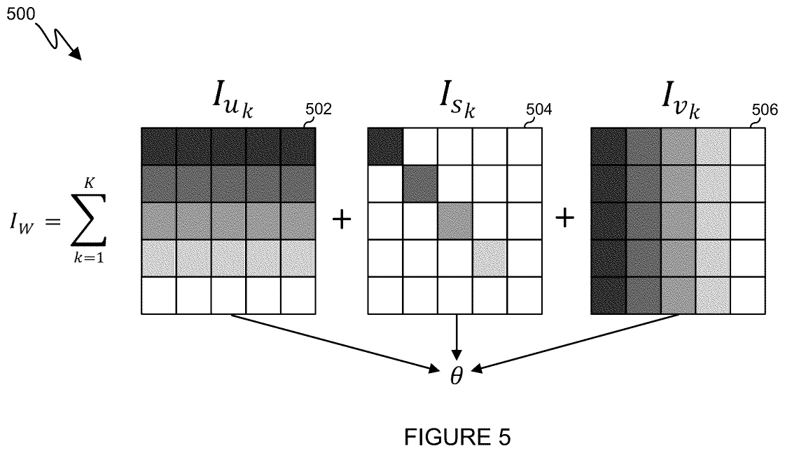

FIG. 5 illustrates an example importance scoring process 500 in accordance with this disclosure. The importance scoring process 500 can correspond to the importance scoring operation 308. For ease of explanation, the process 500 is described as involving the use of the electronic device 101 in the network configuration 100 of FIG. 1. However, the process 500 may be used with any other suitable electronic device (such as the server 106) or a combination of devices (such as the electronic device 101 and the server 106) and in any other suitable system(s).

As shown in FIG. 5, unlike previous compression approaches in which importance is only determined for individual parameters, this disclosure provides for computing the importance score based on a singular group. I(θ) is a score function to measure the change in loss (|Δ [symbol] _{θ}|) after removing parameter θ, which can be the u, σ, v parameters. Thus, given any parameter θ, its importance score can be calculated as follows.

$$I ( θ ) = \vert {Δℒ}_{θ} \vert = \vert ℒ - {ℒ}_{¬} θ \vert = {θ}^{⊤} {∇}_{θ} ℒ$$

Here, [symbol] is the original loss, [symbol] _{¬θ}is the loss after removing parameter θ, and ∇_{θ} [symbol] is the first-order derivative of loss at θ.

This equation for I(θ) can be used to calculate a score for each singular group in the matrices decomposed from the weight matrix W, such as a U matrix 502, an S matrix 504, and a V matrix 506, to obtain three scores Iᵤ_{ₖ}, Iₛ_{ₖ}, and Iᵥ_{ₖ} for each singular group. As shown in FIG. 5, the three scores Iᵤ_{ₖ}, Iₛ_{ₖ}, and Iᵥ_{ₖ} are summed for each singular group to obtain the importance score of the singular-group. Again, unlike previous approaches that computed an importance of merely individual parameters in the weight matrix (such as I_{w} =Σ_{p∈W}Iₚ), the process 500 calculates the importance score based on the triple-group of uₖ, sₖ, and vₖ. In some cases, this can be expressed as follows.

$${I}_{W} = {\sum }_{k = 1}^{K} {I}_{{u}_{k}} + {I}_{{s}_{k}} + {I}_{{v}_{k}}$$

Here, K is the number of singular groups, Iᵤ_{ₖ} is the importance score of k^{th} row in the U matrix, Iₛ_{ₖ} is the importance score of k^{th} element in the S matrix, and Iᵥ_{ₖ} is the importance score of k^{th} column in the V matrix.

Returning to FIG. 3, the importance score 309 for each of the singular groups is output from the importance scoring operation 308. A rank budget calculation operation 310 is also performed to obtain a rank budget 311. In various embodiments, the rank budget 311 is applicable for the whole machine learning model. The rank budget dictates how many singular groups are pruned from the model during the process 300, and the rank budget can change based on the number of time steps used to compress the machine learning model.

For each weight matrix of the model, a pruning operation 312 is performed to remove the least important singular groups based on the importance score for each singular group and the current rank budget. The pruning operation 312 thus works to compress the model by removing the singular groups that have the smallest impact on loss, reducing the size and computational complexity of the model. A determination operation 314 is performed to determine whether the model has been compressed to the desired size, which may be based on a threshold size or computational complexity. If not, the process 300 moves back to the fine-tuning operation 306 to score and prune additional singular groups from the model until the desired model size is achieved. If, at the determination operation 314, it is determined the model has reached the desired size, the process 300 outputs an output model 316. For example, the output model 316 can be the trained and compressed model 202 of FIG. 2.

Although FIG. 3 illustrates one example of a dynamic low-rank estimation and compression process 300, FIG. 4 illustrates one example of a singular group initialization process 400, and FIG. 5 illustrates one example of a importance scoring process 500, various changes may be made to FIGS. 3, 4, and 5. For example, various components and functions in FIGS. 3, 4, and 5 may be combined, further subdivided, replicated, or rearranged according to particular needs. Also, one or more additional components and functions may be included if needed or desired. For instance, the importance rankings shown by the shadings in FIGS. 4 and 5 are merely for example purposes, and different singular groups within the U, S, and V matrices could be deemed to have higher importance depending on the outcomes of the scoring operations described in this disclosure. In some embodiments, the singular group can alternatively include a column of the U matrix and a row of the V matrix. In addition, while shown as a series of steps, various steps in FIGS. 3, 4, and 5 could overlap, occur in parallel, occur in a different order, or occur any number of times (including zero times).

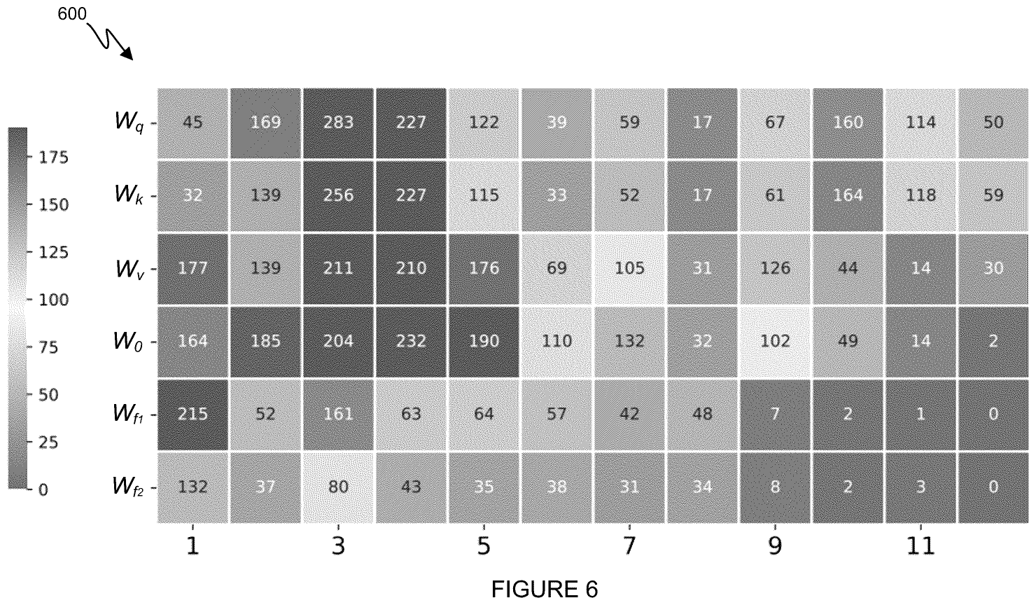

FIG. 6 illustrates an example global ranking allocation 600 in accordance with this disclosure. For ease of explanation, the global ranking allocation 600 is described as involving the use of the electronic device 101 in the network configuration 100 of FIG. 1. However, the global ranking allocation 600 may be used with any other suitable electronic device (such as the server 106) or a combination of devices (such as the electronic device 101 and the server 106) and in any other suitable system(s).

The low-rank estimation and compression techniques of this disclosure can include collectively evaluating the importance of all singular groups within the machine learning model, and therefore different ranks can be assigned to each weight matrix of the machine learning model. The rank for a weight matrix W is calculated for however many non-zero elements are in the S matrix.

Generally, if one matrix is very important to the final model performance, it is assigned with a higher ranks. As shown in the global ranking allocation 600 of FIG. 6, the higher ranks are assigned to important matrices, such as those in the front layers in this example. In the global ranking allocation 600, the horizontal axis denotes the layers in the model, and the vertical axis represents different kind of matrices. For instance, W_{q} is a query matrix, Wₖ is a key matrix, Wᵥ is a value matrix, and W_{f1} and W_{f2} are multilayer perceptron (MLP) or feedforward matrices of the language model. As shown in FIG. 6, the ranking is on a particular example scale, with 100 being neutral (or close to neutral), values between 100-200 being higher rankings, and values between 0-100 being lower rankings. The global ranking of this disclosure thus avoids the assumptions of previous techniques that treat the importance of matrices the same and would essentially rank all the weight matrices as the same or equal.

Although FIG. 6 illustrates one example of a global ranking allocation 600, various changes may be made to FIG. 6. For example, the ranking allocation shown in FIG. 6 is merely for example purposes, and different rankings across the weight matrices could be determined depending on the outcomes of the scoring and ranking operations described in this disclosure.

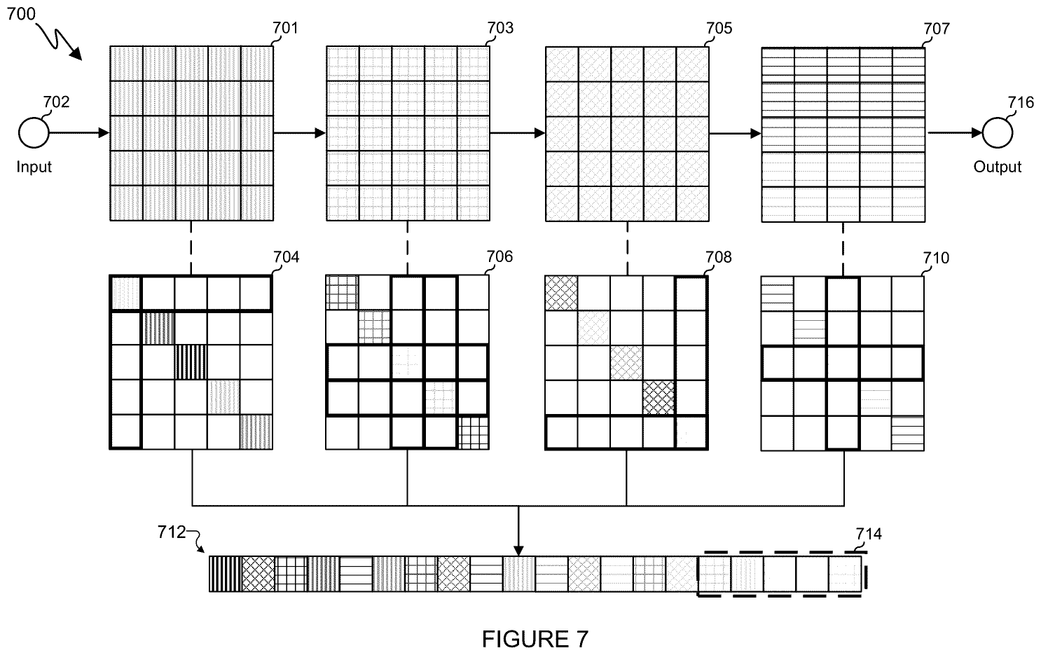

FIG. 7 illustrates an example global ranking and singular group pruning process 700 in accordance with this disclosure. The global ranking and singular group pruning process 700 can correspond to the pruning operation 312 of FIG. 3. For case of explanation, the process 700 is described as involving the use of the electronic device 101 in the network configuration 100 of FIG. 1. However, the process 700 may be used with any other suitable electronic device (such as the server 106) or a combination of devices (such as the electronic device 101 and the server 106) and in any other suitable system(s).

As shown in FIG. 7, the process 700 includes retrieving or receiving an output 702 that includes a plurality of weight matrices. For illustrative purposes, the example shown in FIG. 7 includes a first weight matrix 701, a second weight matrix 703, a third weight matrix 705, and a fourth weight matrix 707. As described in this disclosure, diagonal parameters of an S matrix created from decomposing a weight matrix can be used as an index for the singular groups. As shown in FIG. 7, an S matrix is created from each of the weight matrices 701, 703, 705, 707, resulting in a first S matrix 704, a second S matrix 706, a third S matrix 708, and a fourth S matrix 710, respectively.

As described in this disclosure, each of the S matrices 704, 706, 708, and 710 has diagonal values that form a part of a singular group along with the values of the corresponding U and V matrix rows and columns. In the example of FIG. 7, each S matrix 704, 706, 708, and 710 has five parameters. Based on the scoring of the singular groups, such as based on performance of the importance scoring operation 308, the singular groups associated with a weight matrix can be ranked. For example, as shown by the darker-to-lighter shadings of the S matrix elements in FIG. 7, each of the diagonal elements of S matrix 704 are ranked according to the singular group importance scores, each of the diagonal elements of S matrix 706 are ranked according to the singular group importance scores, and so on, to rank the importance of the singular groups as they pertain to their associated weight matrix.

Additionally, a global rank allocation 712 can be generated based not only on the ranking of the singular groups of an associated weight matrix but across all the weight matrices. For example, as shown in FIG. 7, the global rank allocation 712 collects all the singular groups from all matrices together, sorted by their importance scores. Depending on the current rank budget for the current time step of the compression process, a number of the singular groups can be selected for pruning. For example, as shown in FIG. 7, if the pruning ratio is 0.25, 25% of the singular groups are removed as shown by the group selection 714 in FIG. 7. In this example, two singular groups of the S matrix 706 are removed, while one singular groups of each of the other S matrices 704, 708, 710 are removed. After the singular groups are pruned, compressed weight matrices are provided as an output 716.

Although FIG. 7 illustrates one example of a global ranking and singular group pruning process 700, various changes may be made to FIG. 7. For example, various components and functions in FIG. 7 may be combined, further subdivided, replicated, or rearranged according to particular needs. Also, one or more additional components and functions may be included if needed or desired. For instance, the importance rankings shown by the shading in FIG. 7 are merely for example purposes, and different singular groups within matrices could be deemed to have higher importance depending on the outcomes of the scoring operations described in this disclosure. In addition, while shown as a series of steps, various steps in FIG. 7 could overlap, occur in parallel, occur in a different order, or occur any number of times (including zero times).

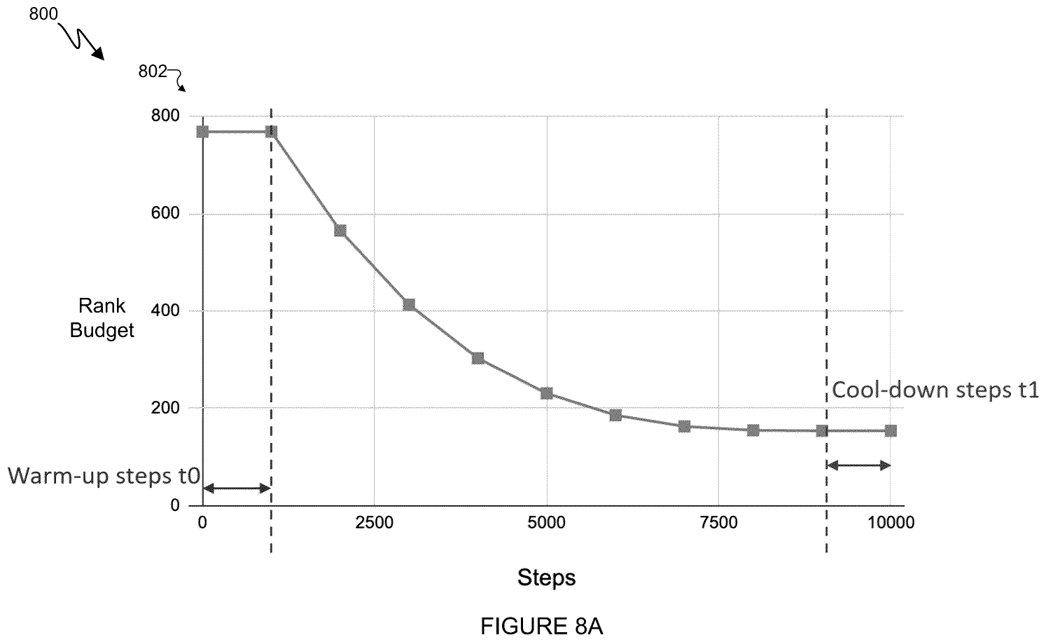

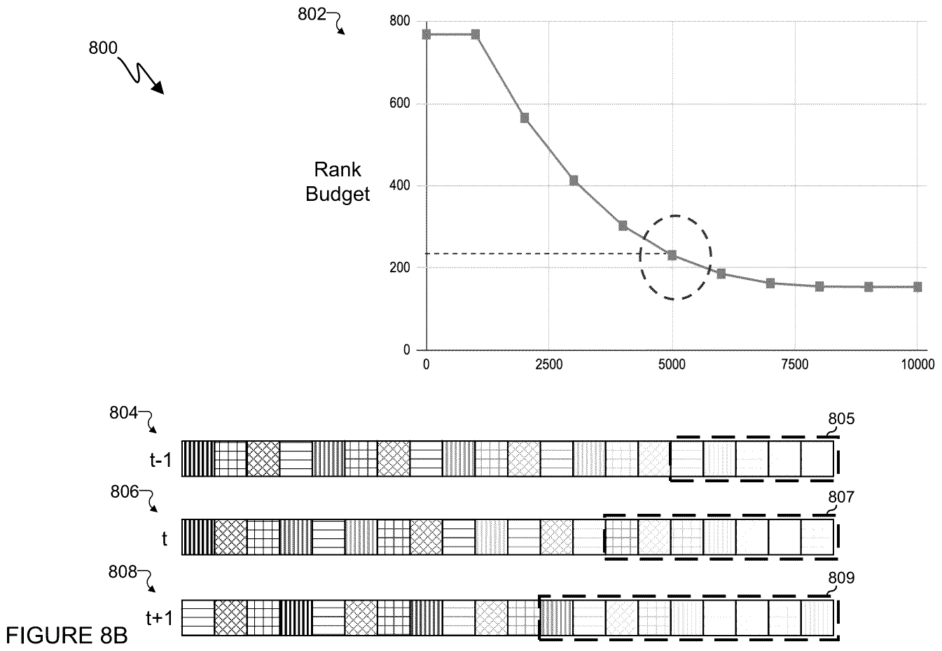

FIGS. 8A and 8B illustrate an example rank budget determination process 800 in accordance with this disclosure. The rank budget determination process 800 can correspond to the rank budget calculation operation 310 of FIG. 3 and can also include the pruning operation 312 in some embodiments. For case of explanation, the process 800 is described as involving the use of the electronic device 101 in the network configuration 100 of FIG. 1. However, the process 800 may be used with any other suitable electronic device (such as the server 106) or a combination of devices (such as the electronic device 101 and the server 106) and in any other suitable system(s).

As shown in FIGS. 8A and 8B, the dynamic low-rank estimation processes of this disclosure allow for the gradual reduction of the matrix rank budget level. The systems and processes of this disclosure aim to compress a pre-trained language model M by decomposing the weight matrices set W in its linear layers. For transformer-based models, W includes various types of weight matrices, such as W_{q} (query), Wₖ (key), Wᵥ (value), Wₒ(attention output), W_{f1} (first FFN), and W_{f2} (second FFN). At the initial step (denoted as step 0), the total number of ranks R⁽⁰⁾ in all matrices of model M can be computed as follows.

$${R}^{( 0 )} = {\sum }_{W ∈ 𝒲} {l}_{W}$$

Here, l_{w} is the original rank number of matrix W.

Given the desired compression ratio c, the targeted number of overall ranks R^{(T)} after T steps of fine-tuning can be determined as follows.

$${R}^{( T )} = ⌈ c \cdot {R}^{( 0 )} ⌉$$

Here, [symbol] is the rounding up operator. Given a targeted rank budget R^{(T)}, the goal is to search for the optimal resource allocation for model M. For example, given matrices of original rank R⁽⁰⁾ (such as 768 for Bidirectional Encoder Representations from a Transformers (BERT) attention model), a reduced rank R^{(T)} (such as 154 of a BERT attention model (20% of the original 768 ranks)), and a target compression completion within steps T (such as 10,000 steps), the rank budget at each time step can be computed. As a particular example, the following equation could be used to compute the rank budget for each time step.

$${R}^{( t )} = {R}^{( T )} + ⌈ ( {R}^{( 0 )} - {R}^{( T )} ) {( 1 - \frac{t - {t}_{0}}{T - {t}_{0} - {t}_{1}} )}^{3} ⌉$$

Thus, as shown in the example rank budget chart 802 in FIG. 8A, the rank budget gradually decreases according to a scheduler as the number of compression steps increase. In some embodiments, as also shown in the example rank budget chart 802 in FIG. 8A, a first set of steps t₀ (the first 1,000 steps in the rank budget chart 802) can be a warm-up phase, and a last set of steps t₁ (the last 1,000 steps in the rank budget chart 802) can be a cool-down phase. As shown in FIG. 8A, during the warm-up and cooldown phases, the budget level does not change. That is, the initial t₀ steps are considered the warm-up phase, during which the current rank budget is kept as R⁽⁰⁾, and the last t₁ steps are treated as the cool-down phase, where the targeted rank budget R^{(T)} has already been attained and is maintained till the end of training.

As shown in FIG. 8B, the process 800 includes selecting singular groups to be pruned based on the rank budget level of the current time step. For instance, as shown in FIG. 8B, according to the rank budget level reduction that is set and as shown in the example rank budget chart 802, the matrix rank budget level is gradually reduced. At each step t, in order to meet the current budget, the least important singular groups are added to a “to-be-pruned” group based on the importance scores of the singular groups, which are determined by the amount of impact the singular groups contribute to the loss. For example, as shown in FIG. 8B, at a current step t of 5000, the rank budget R^{(t)} is at 231. If there are M matrices (such as 100 matrices) of original rank R⁽⁰⁾ (such as 768) in the model being compressed, at the current step t, M(R⁽⁰⁾−R^{(t)}) singular-groups are added to to-be-pruned group.

In some embodiments, to evaluate the importance differences among parameters across different weight matrices, two sets of sin-gular groups are maintained, including: (1) the local remaining set Φ(W), which includes all singular groups of weight matrix W; and (2) the global remaining set Φ( [symbol] ), which is the union of all local remaining sets. Initially, the remaining set Φ( [symbol] )⁽⁰⁾ contains all singular groups in the model [symbol] , thus |Φ( [symbol] )⁽⁰⁾| is equal to R (0). At step t, for any singular group ϕ, if its importance score I(ϕ^{(t)}) is not among the top-R^{(t)} of Φ( [symbol] )^{(t)}, ϕ (can be removed from both the global remaining set Φ( [symbol] )^{(t)} and the local remaining set Φ(W)^{(t)}.

As further shown in FIG. 8B, at a previous time step (t−1), based on the rank budget level, a ranking of singular groups 804 includes a set of singular groups 805 to be pruned including a first number of singular groups. At the current time step (t), based on the rank budget level, a ranking of singular groups 806 includes a set of singular groups 807 to be pruned including a second number of singular groups that is higher than the first number of singular groups of the previous time step (t−1). This follows for subsequent time steps such that, at a next time step (t+1), based on the rank budget level, a ranking of singular groups 808 includes a set of singular groups 809 to be pruned including a third number of singular groups that is higher than both the first and second numbers of singular groups of the previous time step (t−1) and current time step (t).

Although FIGS. 8A and 8B illustrate one example of rank budget determination process 800, various changes may be made to FIGS. 8A and 8B. For instance, the importance rankings, budget level values, number of time steps, etc., shown in FIGS. 8A and 8B are merely for example purposes, and different importance rankings, budget level values, number of time steps, etc., could be used.

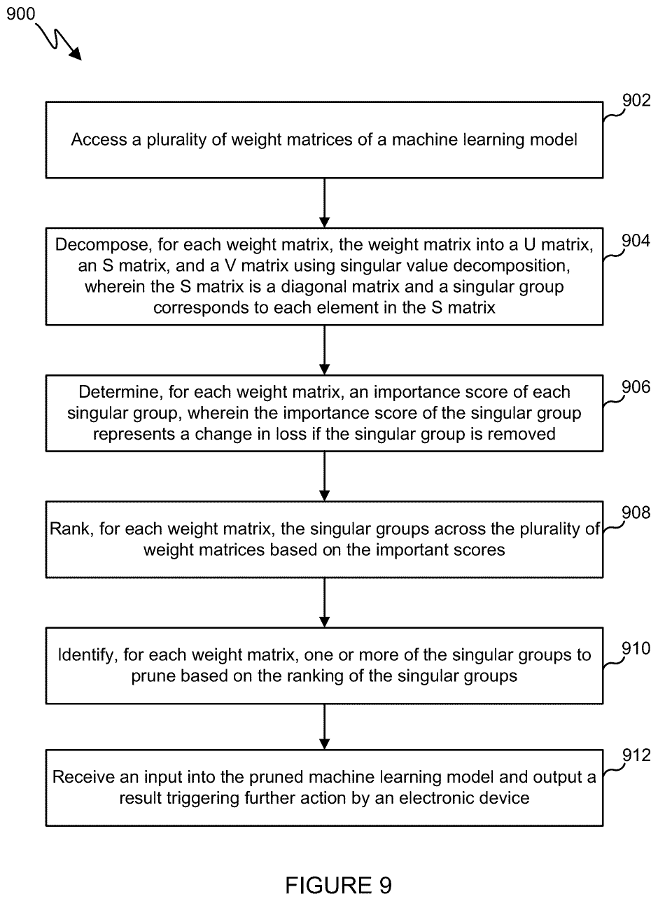

FIG. 9 illustrates an example method 900 for dynamic low-rank estimation and compression in accordance with this disclosure. For ease of explanation, the method 900 shown in FIG. 9 is described as being performed using the electronic device 101 in the network configuration 100 of FIG. 1. However, the method 900 could be performed using any other suitable device(s), such as the server 106, and in any other suitable system(s).

At step 902, a plurality of weight matrices of a machine learning model is accessed. In various embodiments, the machine learning model is a transformer model. Also, in various embodiments, the plurality of weight matrices includes one or more of a query weight matrix, a key weight matrix, a value weight matrix, and a feedforward network weight matrix. Step 902 can include the processor 120 of the electronic device 101 retrieving or receiving an input model to be compressed such as the input model 302 of FIG. 3.

At step 904, for each weight matrix of the accessed plurality of weight matrices, the weight matrix is decomposed into a U matrix, an S matrix, and a V matrix, such as by using singular value decomposition. This can include the processor 120 of the electronic device 101 performing the initialization operation 304 of FIG. 3. As described in this disclosure, the S matrix is a diagonal matrix and a singular group corresponds to each element in the S matrix. As also described in this disclosure, in various embodiments, the singular group can include a column or row of the U matrix, an element of the S matrix, and a column or row of the V matrix.

At step 906, an importance score of each singular group in the weight matrix is determined. This can include the processor 120 of the electronic device 101 performing the importance scoring operation 308 of FIG. 3. As described in this disclosure, the importance score of the singular group represents a change in loss if the singular group is removed from the machine learning model. In various embodiments, the importance score of the singular group is a sum of a first importance score for the column or row of the U matrix, a second importance score for the element of the S matrix, and a third importance score for the column or row of the V matrix. The first importance score represents a change in loss if the respective column or row of the U matrix is removed, the second importance score represents a change in loss if the respective element of the S matrix is removed, and the third importance score represents a change in loss if the respective column or row of the V matrix is removed.

At step 908, the singular groups of each of the plurality of weight matrices are ranked across the plurality of weight matrices based on the importance scores. At step 910, one or more of the singular groups are identified for pruning based on the ranking of the singular groups. This can include the processor 120 of the electronic device 101 performing the rank budget calculation operation 310 and the pruning operation 312 of FIG. 3. Pruning of the identified singular groups can include updating the U matrix, the S matrix, and the V matrix of the plurality of weight matrices to remove the identified one or more of the singular groups. At step 912, an input is received into the pruned machine learning model, and the pruned machine learning model outputs a result that triggers further action by an electronic device, such as the electronic device 101. For example, an audio input of “navigate to the nearest grocery store,” for instance, could be received by the electronic device. The pruned machine learning model can receive the input and convert the audio input into text that is then used by an NLU (which could also be a pruned model in accordance with this disclosure) to convert the text to a user intention. The user intention can then be used by the electronic device trigger a mapping application that outputs on a display of the electronic device a user interface showing a map and directions to a grocery store.

Although FIG. 9 illustrates one example of a method 900 for dynamic low-rank estimation compression, various changes may be made to FIG. 9. For example, while shown as a series of steps, various steps in FIG. 9 could overlap, occur in parallel, occur in a different order, or occur any number of times (including zero times).

It should be noted that the functions shown in FIGS. 2 through 9 or described above can be implemented in an electronic device 101, 102, 104, server 106, or other device(s) in any suitable manner. For example, in some embodiments, at least some of the functions shown in FIGS. 2 through 9 or described above can be implemented or supported using one or more software applications or other software instructions that are executed by the processor 120 of the electronic device 101, 102, 104, server 106, or other device(s). In other embodiments, at least some of the functions shown in FIGS. 2 through 9 or described above can be implemented or supported using dedicated hardware components. In general, the functions shown in FIGS. 2 through 9 or described above can be performed using any suitable hardware or any suitable combination of hardware and software/firmware instructions. Also, the functions shown in FIGS. 2 through 9 or described above can be performed by a single device or by multiple devices. For instance, the server 106 might be used to train and/or compress the machine learning model 202, and the server 106 could deploy the trained and/or compressed machine learning model 202 to one or more other devices (such as the electronic device 101) for use.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
accessing a plurality of weight matrices of a machine learning model; and
for each weight matrix:
decomposing the weight matrix into a U matrix, an S matrix, and a V matrix using singular value decomposition, wherein the S matrix is a diagonal matrix and a singular group corresponds to each element in the S matrix;
determining an importance score of each singular group, wherein the importance score of the singular group represents a change in loss if the singular group is removed from the machine learning model;
ranking the singular groups across the plurality of weight matrices based on the importance scores; and
identifying one or more of the singular groups to prune based on the ranking of the singular groups.

2. The method of claim 1, wherein the machine learning model is a transformer model.

3. The method of claim 1, further comprising:
updating the U matrix, the S matrix, and the V matrix to prune the identified one or more of the singular groups.

4. The method of claim 1, wherein each singular group includes:
a column or row of the U matrix;
an element of the S matrix; and
a column or row of the V matrix.

5. The method of claim 4, wherein the importance score of the singular group is a sum of:
a first importance score for the column or row of the U matrix;
a second importance score for the element of the S matrix; and
a third importance score for the column or row of the V matrix.

6. The method of claim 5, wherein:
the first importance score represents a change in loss if the respective column or row of the U matrix is removed;
the second importance score represents a change in loss if the respective element of the S matrix is removed; and
the third importance score represents a change in loss if the respective column or row of the V matrix is removed.

7. The method of claim 1, wherein the plurality of weight matrices includes one or more of:
a query weight matrix;
a key weight matrix;
a value weight matrix; and
a feedforward network weight matrix.

8. An electronic device comprising:
at least one processing device configured to:
access a plurality of weight matrices of a machine learning model; and
for each weight matrix:
decompose the weight matrix into a U matrix, an S matrix, and a V matrix using singular value decomposition, wherein the S matrix is a diagonal matrix and a singular group corresponds to each element in the S matrix;
determine an importance score of each singular group, wherein the importance score of the singular group represents a change in loss if the singular group is removed from the machine learning model;
rank the singular groups across the plurality of weight matrices based on the importance scores; and
identify one or more of the singular groups to prune based on the ranking of the singular groups.

9. The electronic device of claim 8, wherein the machine learning model is a transformer model.

10. The electronic device of claim 8, wherein the at least one processing device is further configured to update the U matrix, the S matrix, and the V matrix to prune the identified one or more of the singular groups.

11. The electronic device of claim 8, wherein each singular group includes:
a column or row of the U matrix;
an element of the S matrix; and
a column or row of the V matrix.

12. The electronic device of claim 11, wherein the importance score of the singular group is a sum of:
a first importance score for the column or row of the U matrix;
a second importance score for the element of the S matrix; and
a third importance score for the column or row of the V matrix.

13. The electronic device of claim 12, wherein:
the first importance score represents a change in loss if the respective column or row of the U matrix is removed;
the second importance score represents a change in loss if the respective element of the S matrix is removed; and
the third importance score represents a change in loss if the respective column or row of the V matrix is removed.

14. The electronic device of claim 8, wherein the plurality of weight matrices includes one or more of:
a query weight matrix;
a key weight matrix;
a value weight matrix; and
a feedforward network weight matrix.

15. A non-transitory machine readable medium containing instructions that when executed cause at least one processor of an electronic device to:
access a plurality of weight matrices of a machine learning model; and
for each weight matrix:
decompose the weight matrix into a U matrix, an S matrix, and a V matrix using singular value decomposition, wherein the S matrix is a diagonal matrix and a singular group corresponds to each element in the S matrix;
determine an importance score of each singular group, wherein the importance score of the singular group represents a change in loss if the singular group is removed from the machine learning model;
rank the singular groups across the plurality of weight matrices based on the importance scores; and
identify one or more of the singular groups to prune based on the ranking of the singular groups.

16. The non-transitory machine readable medium of claim 15, further containing instructions that when executed cause the at least one processor of the electronic device to update the U matrix, the S matrix, and the V matrix to prune the identified one or more of the singular groups.

17. The non-transitory machine readable medium of claim 15, wherein each singular group includes:
a column or row of the U matrix;
an element of the S matrix; and
a column or row of the V matrix.

18. The non-transitory machine readable medium of claim 17, wherein the importance score of the singular group is a sum of:
a first importance score for the column or row of the U matrix;
a second importance score for the element of the S matrix; and
a third importance score for the column or row of the V matrix.

19. The non-transitory machine readable medium of claim 18, wherein:
the first importance score represents a change in loss if the respective column or row of the U matrix is removed;
the second importance score represents a change in loss if the respective element of the S matrix is removed; and
the third importance score represents a change in loss if the respective column or row of the V matrix is removed.

20. The non-transitory machine readable medium of claim 15, wherein the plurality of weight matrices includes one or more of:
a query weight matrix;
a key weight matrix;
a value weight matrix; and
a feedforward network weight matrix.
